(19) United States
(12) Patent Application Publication
(10) Pub. No.: US 2018/0289566 A1
(43) Pub. Date: Oct. 11, 2018

(54) ELECTRICALLY ACTUATED WHEELED STRETCHER SYSTEM

(71) Applicant: Sechrist Industries, Inc., Anaheim, CA (US)

(72) Inventors: Deepak Ambalal Talati, Yorba Linda, CA (US); Teofilo Raymund G. Tann, III, Anaheim, CA (US); Fernando Cendejas, Anaheim, CA (US); Thuan Cong Le, Cypress, CA (US)

(21) Appl. No.: 15/718,352

(22) Filed: Sep. 28, 2017

Related U.S. Application Data
(60) Provisional application No. 62/482,540, filed on Apr. 6, 2017.

(51) Int. Cl. A61G 1/003; A61G 1/02; A61G 1/048

(52) U.S. Cl. CPC A61G 1/003; A61G 2203/10; A61G 1/048; A61G 1/0243

(57) ABSTRACT

An electrically actuated wheeled stretcher system which is adapted to provide electrically actuated raising or lowering of a stretcher mounted on a gurney. The system is primarily composed of a stretcher and a gurney, and may be used to transport patients and load and unload the patients by automated transfer of the stretcher from the gurney to other medical equipment, for example, a hyperbaric chamber, and automated transfer from the other medical equipment back on to the gurney. The system further includes an additional electrically actuated fifth wheel configured to provide smoother turning and rotation in place of the system. The system further includes continuous treatment items, such as intravenous fluid and medical gasses to travel with the system.

### CROSS-REFERENCE TO RELATED APPLICATIONS

This application claims the benefit of U.S. Provisional Application Ser. No. 62/482,540, filed Apr. 6, 2017, the disclosure of which is herein incorporated by reference in its entirety.

### STATEMENT RE: FEDERALLY SPONSORED RESEARCH/DEVELOPMENT

Not Applicable

### BACKGROUND

### 1. Technical Field of the Invention

The present disclosure relates generally to wheeled hospital gurney !stretcher systems and, more particularly, to a modular wheeled gurney/stretcher system with an electrically powered to height adjustment which allows transfer the stretcher portion from the gurney to various other locations.

### 2. Description of the Related Art

Gurneys are widely used in hospitals to move patients for any number of reasons. For example, patients may need to be moved from a standard room to an operating room. Patients may also need to be moved from their room to various therapy locations. One such therapy location may be a hyperbaric chamber. Hyperbaric chambers are well known in treating decompression sickness, commonly known as the bends, which is a condition that may be caused by a scuba diver ascending too quickly. With the bends, the change in pressure causes dissolved gasses to come out of solution and form bubbles in the blood stream. A hyperbaric chamber may also be useful in treating serious infections, bubbles of air in blood vessels, burns, and wounds that won't heal as a result of diabetes or radiation injury.

Current gurneys are height adjustable. However, in the state of art, height adjustment is carried out by pneumatic or hydraulic means, with the most common being a hydraulic cylinder actuated by some type of mechanical means. The actuator is most often a foot pump. This can lead to a bouncing of the gurney and attached stretcher as the system is raised.

Additionally, current gurneys have casters, but have a tendency to overreact to force applied to them, causing the gurney to oversteer to the left or right. When transferring a patient, this can lead to jarring of the patient when the gurney contacts the walls of a hyperbaric chamber, for example. Many patients, for example burn victims, and those with wounds that won't heal, are sensitive to such jarring and bumping. In fact, anything beyond the most minor of these can cause such patients pain.

### BRIEF SUMMARY

In accordance with the present disclosure, there may be provided an electrically actuated wheeled stretcher system which may be adapted to provide smooth adjustment of the height of the stretcher. In greater detail, the stretcher system of the present disclosure may be primarily composed of a gurney chassis, a stretch support frame mounted above the the gurney chassis, and a stretcher on the stretcher support frame. An electric elevation system may be used to raise and lower one or more electrically actuated telescoping columns. The electric elevation system may include one or more electrically actuated telescoping columns that may be mounted on the gurney chassis and the stretcher support frame. The electric elevation system may further include a handset that may be mounted on the stretcher system and connected to the at least one electrically actuated column. A rechargeable battery may be connected to the electric elevation system. The electric elevation system may move the electrically actuated wheeled stretcher system between a raised and lowered position, and to any position in between, based on a user's operation of the handset.

Also disclosed is a method for manufacturing an electrically actuated gurney system. The method may include providing a gurney chassis, and attaching at least one electrically actuated column to the gurney chassis. The method may further include mounting a stretcher support frame to the at least one electrically actuated column. The method may also include providing a battery in electrical communication with at least one electrically actuated column. At least one electrically actuated column is raised or lowered by a user by operating a control on the gurney system.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 shows a perspective view of the gurney system;

FIG. 2 shows a side view of the gurney system;

FIG. 3 shows an exploded view of the gurney chassis, electrically ac ed telescoping columns, and stretcher support frame;

FIG. 4 shows a side view of the gurney system rotated 90 degrees from the view in FIG. 2;

FIG. 5 shows an exploded detail view of the battery and electrical compartments of the stretcher support frame;

FIG. 6 shows a schematic diagram of the wiring and electrical components of the gurney system;

FIG. 7 shows another perspective view of the gurney system;

FIG. 8 shows a perspective view of the opposite side of the gurney system from that shown in FIG. 7; and

FIG. 9 shows a top view of a handset.

### DETAILED DESCRIPTION

100211 The detailed description set forth below in connection with the appended drawings is intended as a description of the presently preferred embodiment of a charging device, and is not intended to represent the only form in which it can be developed or utilized. The description sets forth the functions for developing and operating the adapter in connection with the Illustrated embodiments. It is to be understood, however, that the same or equivalent functions may be accomplished by different embodiments that are also intended to be encompassed within the scope of the present disclosure. It is further understood that the use of relational terms such as first, second, distal, proximal, and the like are used solely to distinguish one from another entity without necessarily requiring or implying any actual such relationship or order between such entities.

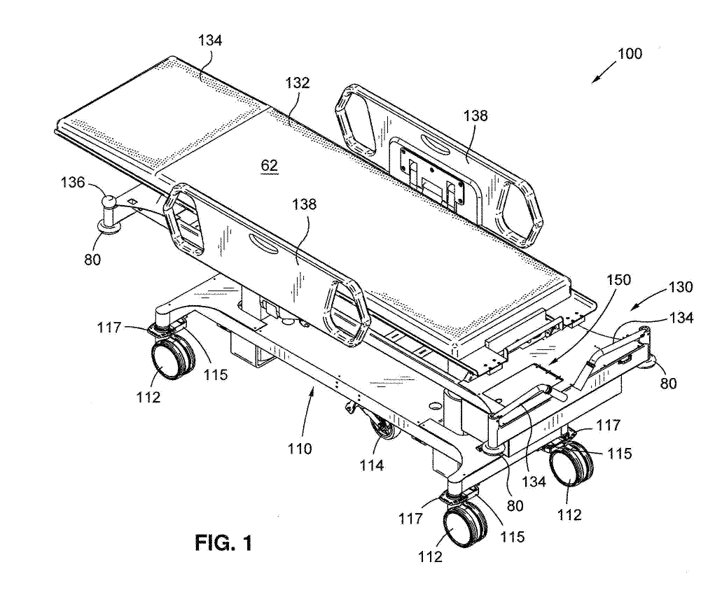

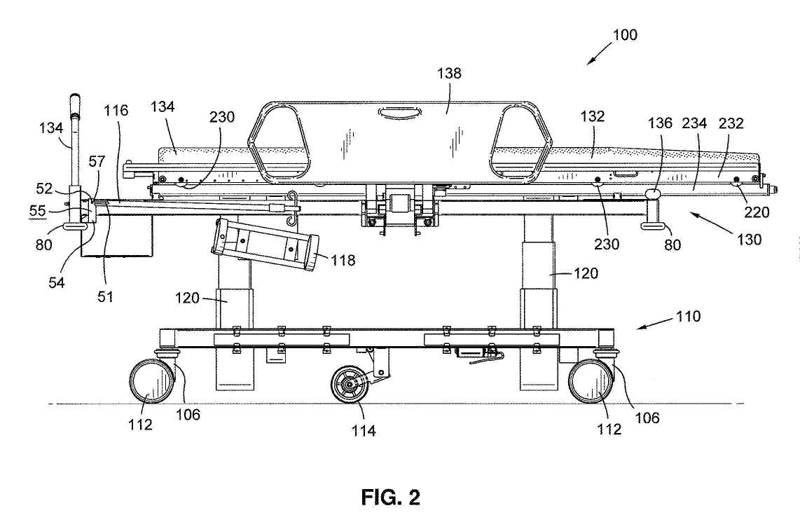

FIGS. 1 and 2 depict aspects of the gurney system 100. Structurally, the system may include a gurney chassis 110, two electrically actuated telescoping columns 120 which are attached on a lower end to the gurney chassis 110, a stretcher support frame 130 attached to the top end of the two electrically actuated telescoping columns 120, and a stretcher 132 with an adjustable headrest 134 which rests on top of the stretcher support frame 130. Mounted on the gurney chassis 110 may be casters 112 and a center mounted fifth wheel 114. Mounted on the stretcher support frame 130 may be push handles 134, knobs 136, and rollers 80. Side Rails 138 may be mounted on the stretcher support frame 130 to either side of the stretcher. 132. The gurney system 100 may further include an IV pole 116 and a medical gas holder 118. Although gurney/stretcher systems 100 with two electrically actuated telescoping columns 120 are described here, it is understood that gurney/stretcher systems 100 with one, or three or more electrically actuated telescoping columns 120 are contemplated. Equally contemplated are gurney/stretcher systems 100 with a combination of actuated columns and support, or non-actuated columns.

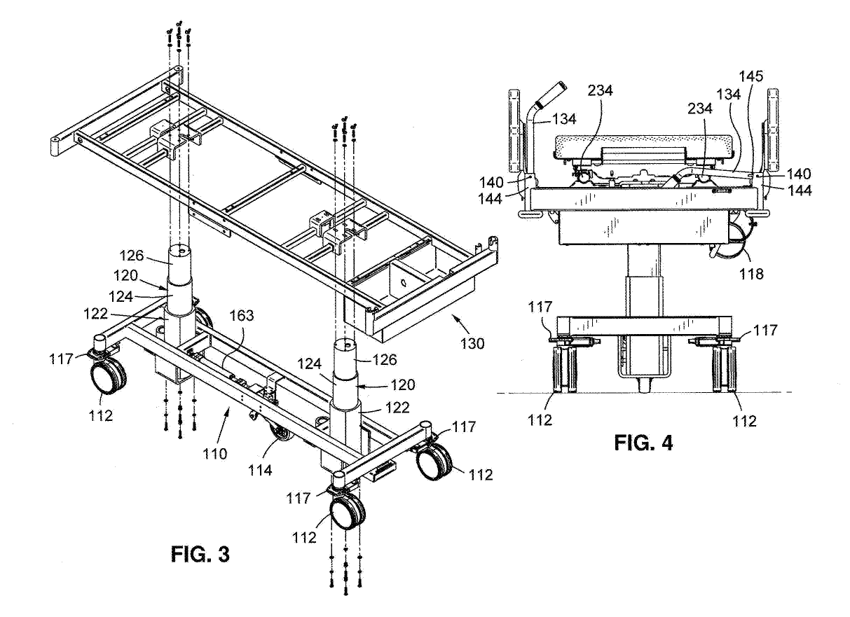

The electrically actuated telescoping columns 120 may be bolted or welded to the gurney chassis 110, or to the stretcher support frame 130. For example, the electrically actuated telescoping columns 120 may be welded to the gurney chassis 110 and bolted to the stretcher support frame 130, or vice versa. As another example, both the connections to the gurney chassis 110 and to the stretcher support frame 130 may be welded, or, as shown in FIG. 3, both may be bolted.

The system 100 may be made mobile by the plurality of casters 112 mounted on the gurney chassis 110. The casters 112 may spin on a vertical axis 360 degrees in order to allow the gurney system 100 to turn on a short radius. When the gurney system 100 is stopped, additional stability may be required to load or unload a patient. To this end, each of the plurality casters 112 may include an electrically actuated brake 115. The electrically actuated brake 115 may use an electric linear actuator equipped with a mechanical fitting (not shown), for example, a gear or stop, to engage with a corresponding mechanical fitting on an interior of a caster housing 106. When the corresponding mechanical fittings are engaged, they may prevent the plurality of casters 112 from turning, effectively locking the plurality of casters 112 in place.

Additionally or alternatively, each of the plurality of casters 112 may include a manual actuation for the brake 115. The manual actuation may include a pedal 117 on each of the plurality casters 112 which may be actuated by a user stepping on the pedal 117. The pedal 117 can be moved from a released position to an engaged position. In the released position the brake 115 allows the caster 112 of which it is a part to turn freely. If there is still electrical power being provided to the gurney system 100, the manual activation of one brake 115 may cause the other three brakes 115 to activate electronically.

When moved to the engaged position, the brake 115 may prevent the caster 112 from rolling, or the caster 112 from rotating around the caster's vertical axis. Thus, the gurney system 100 may be rendered substantially motionless, and a patient (not shown) may be loaded or unloaded, with the patient already on the stretcher 132 or loading the patient to a stretcher 132 already on the gurney system 100.

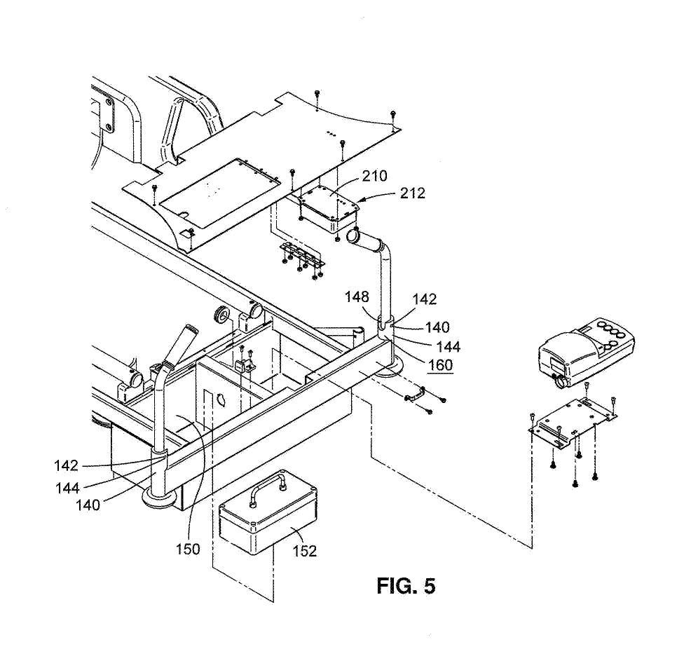

As best seen in FIGS. 4 and 5, the gurney system 100 may include a pair of push handles 134. The push handles 134 may be located on opposing corners of one end of the stretcher support frame 130. The push handle may he formed from an elongated cylindrical body with a bend near one end. A cross section of the elongated cylindrical body may define a circumference. Near an end opposite from the end with the bend, the push handles 134 may include two longitudinal slots 145 in a wall of the elongated cylindrical body. The longitudinal slots 145 may be on opposite points of the circumference. The push handles 134 may have an operative position and a stored position, and may be moved between the two positions. From the stored position, a push handle 134 may be rotated around a pivot point axle 140 at an end of the push handle 134 closest to the stretcher support frame 130. The pivot point axle 140 may be formed by a simple mechanical connector such as a nut and bolt. The push handle 134 may be connected to a push handle base 144. The pivot point axle 140 may pass through holes 142 on opposite sides of a circumference of a push handle base 144. The pivot point axle 140 may further connect the push handle 134 to a push handle base 144. The push handle base 144 may include a cut out 148 along a section of a cylindrical wall 150 of the base 144 that allows the push handle 134 to rotate to the stored position. Alternatively, the gurney system 1.00 may have more than a pair of push handles 134. For example, there might be a push handle on every corner, for a total of four, but any number of push handles is contemplated.

From the stored position the push handles 134 may be rotated about the pivot point axle 140 until the push handle 134 is substantially vertical, and then translated vertically downward, with the pivot point axle 140 moving through the longitudinal slots 145. At the end of the vertical translation the push handle 134 is in the operative position, and the push handle 134 may rest in the push handle base 144, such that the cylindrical wall 150 of the push handle base 144 prevents the push handle 134 from rotating about the pivot point axle 140. From the operative position, the push handle 134 may be translated vertically upward such that the pivot point axle 140 passes through the longitudinal slots 145 in the opposite direction, and then the push handle 134 rotated about the pivot point axle 140 back to the stored position.

The gurney system 100 may further include knobs 136 on each of the corners of the stretcher support frame 130 opposite the push handles 134. The knobs 136 may allow a user to more precisely align the gurney system 100 by manipulating an end of the gurney system 100 closest to another other piece of equipment (not shown) or patient unloading point (not shown). The knobs 136 may be designed to rotate, which saves a user from having to re-grip the knob 136 after moving or moving and rotating the gurney system 100 some distance. Also, not having to re-grip again may allow for smoother manipulation of the gurney system 100.

Rollers 80 may be mounted on the stretcher support frame 130 immediately under the knobs 136 and push handles 134. The rollers 80 allow the gurney system 100 to translate alongside another piece of medical equipment or a wall without scraping the stretcher support frame 130 across the other piece of equipment or wall. The rollers 80, as the name implies, rotate when the rollers 80 are moved across a vertical surface. The rollers 80 may be made of a rubber or polymer which will compress and not mar any surface in contact with the roller.

The side rails 138 may be mounted, one on either side of the stretcher support frame 130. The side rails 138 may be moved from a protective position to a lowered position. In the protective position, the side rails 138 are substantially above a top surface 62 of the stretcher 132. In the lowered position, the side rails 138 are substantially below the top surface 62 of the stretcher 132.

The gurney system 100 may further include an IV pole 116. The IV pole 116 may be formed from an elongated cylindrical body defining a wall 53. A cross section of the elongated cylindrical body may define a circumference. Near one end, the IV pole 116 may have longitudinal slots 51 through the wall 53 of the elongated cylindrical body. The IV pole 116 may include an operative position and a stored position. In the stored position, the IV pole 116 may be horizontal or slightly less than horizontal. From the stored position the IV pole 116 may be rotated around an IV pole pivot point axle 52. The IV pole pivot point axle 52 may be formed by a simple mechanical connector such as a nut and bolt. The IV pole pivot point axle 52 may pass through the longitudinal slots 51 cut in the IV pole 116. The IV pole pivot point axle 52 may further connect the IV pole 116 to an IV pole base 54. The IV pole pivot point axle 52 may pass through holes 57 on opposite sides of a cylindrical wall 55 of the IV pole base 54. The holes 57 and the longitudinal slots 51 of the IV pole may form a common bore. The IV pole base 54 may include a cut out (not shown), similar to the cut out in the push handle base, that allows the IV pole 116 to rotate to the stored position. From the stored position the IV pole 116 may be rotated about the IV pole pivot point axle 52 until the IV pole 116 is substantially vertical, and then translated vertically downward, with the IV pole pivot point axle 52 moving through the longitudinal slots 51. At the end of the vertical translation the IV pole 116 is in the operative position, and the IV pole 116 may rest in the IV pole base 54, such that the cylindrical wall 55 of the IV pole base 54 prevents the IV pole 116 from rotating about the IV pole pivot point axle 52, From the operative position, the IV pole 116 may be translated vertically upward such that the IV pole pivot point axle 52 passes through the longitudinal slots 51 in the opposite direction, and then the IV pole 116 rotated about the IV pole pivot point axle 52 back to the stored position. When in the stored position the end of the IV pole 116 opposite the IV pole pivot point axle 52 may be supported by a storage hook (not shown).

As is further shown in FIGS. 2 and 4, the gurney system 100 may include a medical gas holder 118. The medical gas holder 118 may be configured to hold a bottle or other container (not shown) which contains medical gas, for example oxygen.

The stretcher 132 may include wheels 230 arranged in a longitudinal channel 232 along each underside of the stretcher 132. When the stretcher 132 is loaded on to the gurney system 100 the wheels may rest on and roll along two parallel rails 234 mounted on the stretcher support frame 130. The rails 234 may be tubular, defining a circular cross section, or may have other cross sectional shapes, such as square, rectangular, triangular, or ovoid. As the stretcher 132 is loaded on to the gurney system 100, successive wheels 230 may contact the rails 234, and roll along the rails 234 until the stretcher 132 may be fully loaded on the gurney system 100.

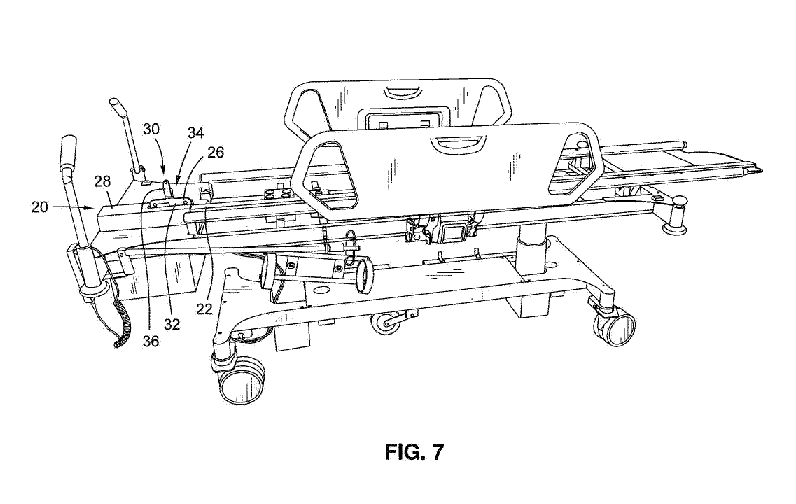

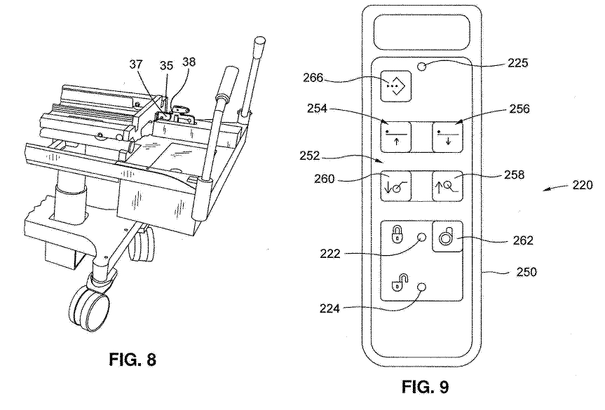

Additionally, as shown in FIG. 7 and FIG. 8, once the stretcher is loaded on the gurney system 100, the system 100 may include a locking device 30 for securely mounting the stretcher 132 to the gurney system 100. The locking device 30 may include an interface 34 between the stretcher 132 and the stretcher support frame 130. For example, the stretcher support frame 130 may have two parallel flanges 32. As shown in FIG. 8, a pin 35, placed perpendicular to the longitudinal axis of the flanges 32 may be aligned with a common bore formed by holes 34 through both of the flanges 32. A stretcher release latch 36 may be attached to at least one of the flanges 32 around a pivot 38. The pivot 38 may be created by a simple mechanical connection such as a nut and bolt combination. The stretcher release latch 36 may rotate around the pivot 38 from a release position to an engaged position. In the release position, as shown in FIG. 7, the stretcher release latch 36 may be vertical and not physically connected to the stretcher 132 at all, such that the stretcher 132 is free to move relative to the stretcher support frame 130. In the engaged position, as shown in FIG. 8, the stretcher release latch 36 may surround a portion of a tongue 35 which extends from, and is attached to the stretcher 132. The tongue 35 may extend from a frame of the stretcher 132 and be placed such that when the stretcher 132 is fully loaded on to the gurney system 100, the tongue 35 rests between the flanges 32. The tongue 35 may further include an aperture 37 which aligns with the holes 34 in the flanges 32. The holes 34 and the aperture 37 may form a common bore through which the pin 33 may pass, effectively locking the stretcher 132 to the stretcher support frame 130.

As can best be seen in FIGS. 1 and 5, the system may further include a battery compartment 150. The battery 152 may power the electrical components of the system.

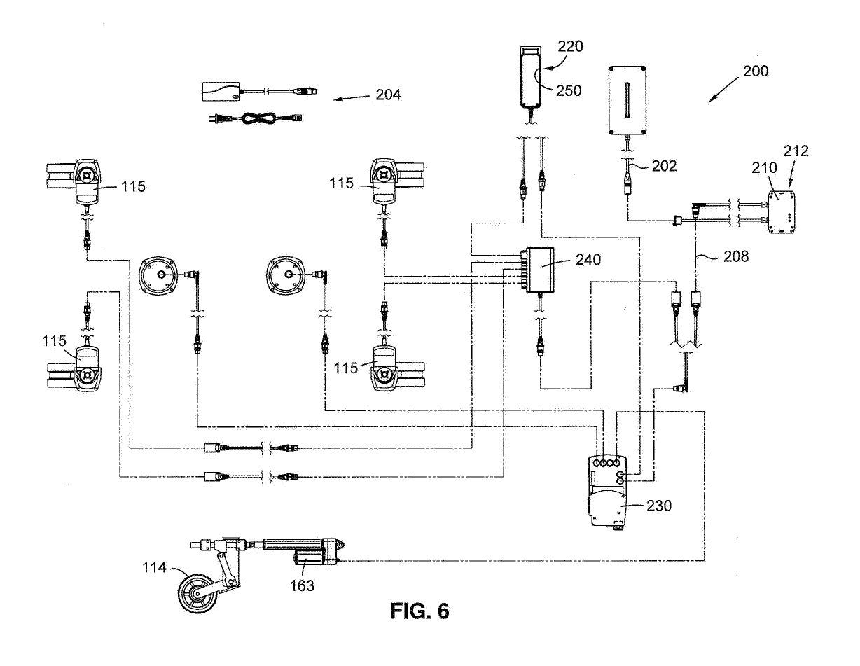

The electrical system 200 is shown in the wiring diagram of FIG. 6. The exemplary electrical system may include a battery 152, a battery monitor 210, a controller 156, two electrically actuated telescoping columns 120, a controller for the brakes 158, an electrically actuated brake 115 for each of the plurality of casters 112, the electrically actuated fifth wheel 114, an in-line controller, a handset 220, and two foot switches for operating the electrical components.

The battery 152 may be removeable. For example, the battery 152 may be unplugged from the gurney system 100 for recharging. To this end, the battery 152 may include a corded connection 202 in order to pass the battery power to the electrical system 200.

Alternatively, or in addition, the electrical system 200 may include a battery 152 which is rechargeable without having to remove the battery 152. The electrical system 200 may include a wired in cord (not shown) which may be plugged directly in to a standard alternating current outlet (not shown). The cord may be stored on the gurney system 100 when not being used to recharge the battery 152. Alternatively, the electrical system 200 may include a detachable chord 204, which may be plugged in to a power source, including an alternating current outlet, that can recharge the battery 152, and connected directly or indirectly to the battery 152 for recharging.

A user may be able to monitor the amount of charge remaining on the battery 152 through the battery monitor 210. The battery monitor 210 may be electrically connected to the battery 152 via wires 208 of the electrical system 200. The battery monitor 210 may be located on a handset 220, which is described in more detail below, or may be located elsewhere on the gurney system 100, for example, on or near the battery compartment 150. The battery monitor 210 may include a series of light emitting diode (LED) lights 212 or a display. The battery monitor 210 may be next to a printed indicator of the charge remaining (not shown). If the battery monitor 210 is a display, the display may display either purely graphical content or purely text based content, or a combination of graphics and text based content. When LED lights 212 are used, each light or a combination of lights may be associated with a certain charge level. For example, there may be four LED lights 212. When all four LED lights 212 are lit, it may indicate a fully charged battery 152. When three LED lights 212 are lit, it may indicate a battery charge level of 75%, two lit LED lights 212 may indicate a charge level of 50%, and one lit LED light 212 a charge level of 25%. While four LED lights 212 have been used as an example, other numbers of LED lights 212 to indicate differing levels of battery charge are also contemplated. For example, three LED lights 212, including two green and one amber or yellow LED lights, may be used. Two lit green LED lights 212 indicate the battery charge level as 75% or greater, one lit green LED light 212 a charge level between 75% and 50%, and one lit amber/yellow LED light 212 a charge level less than 50%. Alternatively, the battery monitor 152 may offer a more precise charge level. For example, the battery monitor 152 may have a digital readout of a charge level expressed as a percentage.

The electrically actuated telescoping columns 120 may include a plurality of sections 122, 124, 126. For example, an electrically actuated telescoping column may include three sections 122, 124, 126. Each section may have a hollow cylindrical shape. The sections may be sized so that each successive section may have an outer diameter less than an inner diameter of the previous section. Each telescoping column section may be slidingly engaged to the one before it, so that, when actuated, the next section can extend from an upper end of the previous section in a successive, telescoping manner. A first 122, largest diameter section may be attached on a lower end to the gurney chassis. A smallest diameter third section 126 may attach on an upper end to the stretcher support frame 130. A second telescoping column section 124 may he attached to both the first telescoping column section 122 and third telescoping column section 126. Although electrically actuated columns of three sections have been described here, columns of as few as two sections, as well as columns of four sections or more are contemplated.

Each electrically actuated telescoping column 120 may include at least one electric linear actuator (not shown). The smallest diameter section 126 of the electrically actuated telescoping column 120 may have a larger diameter than the electric linear actuator, and the electric linear actuator may be attached to an interior of the smallest section 126 on the electrically actuated telescoping column 120. Alternatively, there may be a first electric linear actuator to extend the second section 124 from the first section 122, and a second electric linear actuator to extend the third section 126 from the second section 124. The electrical linear actuators are very smooth in operation. In contrast, a hydraulically actuated column operates with pulses of power and movement, rather than continuous movement like an electrically actuated column 120. The pulsed movement may cause patients on gurney systems powered hydraulically to experience pain as the patient is bounced by the pulses. The smooth movement of an electrically actuated gurney system 100 all but removes this source of pain. If there may he more than one electric linear actuator, the controller 230 may transition battery power from one electric linear actuator to another so that there is no time gap in movement of the electrically actuated column or columns 120.

As shown in FIG. 7, the gurney system 100 may include a drive 20 which loads or unloads the stretcher 132 from the gurney system 100. The drive 20 may be useful when transferring a patient from the gurney system 100 to another medical device, such as a hyperbaric chamber (not shown). The drive 20 for loading or unloading may include a nut or threaded collar (not shown) on the stretcher 132. The nut or threaded collar may then interface with a threaded drive shaft 22 on the gurney system 100. The threaded collar (not shown) on the stretcher may pass over a first end 24 of the threaded drive shaft 22. The second, or opposite end 26 of the threaded drive shaft 22 may be attached to a drive motor 28 which rotates the threaded drive shaft 22. The motor 28 may include gearing (not shown) which changes the revolutions per minute of the motor, which may either gear up or gear down the revolutions per minute maximum or minimum of the motor. The motor may be controlled from the handset 220 or may be controlled from a different set of controls. The drive motor 28 may be powered by the battery 152.

The electrically actuated wheel, also called a fifth wheel 114 may operate in coordination with the plurality of casters 112. The electrically actuated wheel 114 may be located substantially in the center of the plurality of casters 112, and may be mounted to the gurney chassis 110. As seen in FIGS. 3 and 6, an electric linear actuator 163 may raise or lower the fifth wheel 114. When the electrically actuated wheel 114 is raised, it may be in a stored position, and is not involved in the operation of the gurney system 100. When the electrically actuated wheel 114 is lowered, it may be placed in an operative position, where the electrically actuated wheel 114 aids in the turning stability of the gurney system 100.

The gurney system 100 may further include a handset 220 which may provide a user interface for many of the electrically actuated functions of the gurney system 100. The handset 220 may be connected with the other components of the electrical system 200 through a controller via either wired or wireless connections. There may be more than one controller. For example, there may be a dedicated controller 158 for just the electric brakes 115 on the casters 112, and a separate controller 156 for all the other electrical components.

As shown in FIG. 9, the handset 220 may include a housing 250. The handset 220 may also include an LED indicator light 225 which indicates if the battery 152 is providing power to the handset 220. On one side of the housing 250 the handset may include at least one button 252 to control electrically actuated functions of the gurney system 100. For example, the handset 220 may include a button 254 for raising and a button. 256 for lowering the gurney system 100, specifically, the height of the stretcher support frame 130 and the stretcher 132 mounted thereon, by operating the electric linear actuators in the electrically actuated telescoping columns 120. Alternatively, the handset 220 may include a single button with two areas, where one area would control the raising and another area would control the lowering the height of the stretcher support frame 130, and the stretcher 132 mounted thereon.

The handset 220 may include a button 258 for raising, and a button 260 for lowering, the electrically actuated wheel 114. Alternatively, the handset 220 may include a single button with two areas. Pressing on the first area would raise the electrically actuated wheel 114, and pressing on the second area would lower the electrically actuated wheel 114.

The handset 220 may include a single button for unlocking the brakes 115 on each of the casters 112. A first press of the button 262 may lock the casters 112, and a second press of the button may unlock the brakes 115 on each of the casters 112, or vice versa. The handset 220 may include led indicators 222, 224 combined with graphics printed on a face 251of the handset 220 to indicate a locked or unlocked condition for the brakes 115. As an alternative, the handset 220 may also include a button for locking, and a button for unlocking the brake on each of the plurality of casters 112.

In addition to the buttons that control system functions, the handset 220 may include a button 266 that accesses a memory feature. The memory feature may include an electronic storage (not shown) such as a memory chip. When the memory button 266 on, the handset 220 is pressed and held for a predetermined amount of time, the current position of the electrically actuated telescoping columns 120 is entered in to the memory.

Alternatively, or in addition, the electrically actuated wheeled stretcher system may include at least one foot switch. The foot switch may consist of at least one pedal. The foot switch may be used to activate an electrically actuated column 120 or an electrically actuated wheel 114. The foot switch may be connected with the other components of the electrical system 200 via either wired or wireless connections. For example, as shown in FIG. 6, the electrically actuated wheeled stretcher system may include two foot switches 270, which may be mounted on the gurney chassis 110. Each foot switch may include two pedals. One pedal of the foot switch may be used to raise at least one electrically actuated column 120, and the other pedal may be used to lower at least one electrically actuated column 120.

The above description is given by way of example, and not limitation. Given the above disclosure, one skilled in the art could devise variations that are within the scope and spirit of the invention disclosed herein, including various ways of wiring the different electrical components of the system. Further, the various features of the embodiments disclosed herein can be used alone, or in varying combinations with each other and are not intended to be limited to the specific combination described herein. Thus, the scope of the claims is not to be limited by the illustrated embodiments.

1. An electrically actuated wheeled stretcher system, comprising:
a gurney chassis;
an electric elevation system mounted on the gurney chassis and the stretcher support frame, including:
at least one electrically actuated telescoping column extending between the gurney chassis and the stretcher support frame;
a handset mounted on the stretcher system and connected to the at least one electrically actuated column; and
at least one foot switch mounted on the gurney chassis and connected to the at least one electrically actuated telescoping column;
a stretcher support frame with a stretcher removably attached to the stretcher support frame, and the stretcher support frame mounted to the electric elevation system; and
a battery connected to the electric elevation system;
wherein the electric elevation system moves the electrically actuated wheeled stretcher system between a raised and lowered position, and to any position in between, based on a user's operation of the handset or the at least one foot switch.

2. The electrically actuated wheeled stretcher system of claim 1, further comprising at least two push handles.

3. The electrically actuated wheeled stretcher system of claim 2, wherein the at least two push handles move from an operative to a stored position.

4. The electrically actuated wheeled stretcher system of claim 1, wherein the handset further includes a button for a memory feature.

5. The electrically actuated wheeled stretcher system of claim 5, wherein the memory feature returns the electrically actuated wheeled stretcher system to a height stored in a memory of the electrically actuated wheeled stretcher system.

6. The electrically actuated wheeled stretcher system of claim 5, wherein the height is stored in a memory by pressing the button for a predetermined period of time.

7. The electrically actuated wheeled stretcher system of claim 1, further comprising electrically actuated brakes which prevent movement of a plurality of casters mounted on the gurney chassis.

8. The electrically actuated wheeled stretcher system of claim 7, wherein the electrically actuated brakes may be operated by a button on a handset in electrical communication with the electrically actuated brakes.

9. The electrically actuated wheeled stretcher system of claim 7, wherein the electrically actuated brakes may be operated by applying pressure to a plate on one of the plurality of casters.

10. The electrically actuated wheeled stretcher system of claim 1, further comprising casters on the gurney, the casters each including a brake.

11. The electrically actuated wheeled stretcher system of claim 10, wherein each of the brakes may be operated manually.

12. The electrically actuated wheeled stretcher system of claim 1, further comprising an electrically actuated fifth wheel.

13. The electrically actuated wheeled stretcher system of claim 12, wherein the electrically actuated firth wheel may be raised or lowered using the handset.

14. The electrically actuated wheeled stretcher system of claim 1, further comprising a battery monitor.

15. The electrically actuated wheeled stretcher system of claim 14, wherein the battery monitor includes a plurality of LED lights.

16. The electrically actuated wheeled stretcher system of claim 1, wherein the stretcher includes a plurality of wheels which ride along a pair of corresponding tubular bars attached to the stretcher support frame.

17. The electrically actuated wheeled stretcher system of claim 1, further comprising a stretcher release latch which, when in an engaged position, locks the stretcher to the stretcher support frame.

18. The electrically actuated wheeled stretcher system of claim 18, further comprising a pin which further locks a tongue of the stretcher to at least one flange attached to the gurney.

19. The electrically actuated wheeled stretcher system of claim 1, further comprising a drive system which mounts or offloads the stretcher from the stretcher support frame.

20. A method for manufacturing an electrically actuated gurney system, comprising:
providing a gurney chassis;
attaching at least one electrically actuated column to the gurney chassis;
mounting a stretcher support frame to the at least one electrically actuated column;
removably attaching a stretcher to the stretcher support frame; and
providing a battery in electrical communication with the at least one electrically actuated column;
wherein the at least one electrically actuated column is raised or lowered by a user by operating a control on the gurney system.
